(19) United States
(12) Patent Application Publication
(10) Pub. No.: US 2022/0039557 A1
(43) Pub. Date: Feb. 10, 2022

(54) CHAIR BACKREST SWING STRUCTURE

(71) Applicant: ZHEJIANG SUNON FURNITURE MANUFACTURE CO., LTD., Zhejiang (CN)

(72) Inventors: Liangzheng NI, Zhejiang (CN); Xujun ZHANG, Zhejiang (CN); Li MAO, Zhejiang (CN); Jie SUN, Zhejiang (CN); Zhihua ZHU, Zhejiang (CN); Jie SHEN, Zhejiang (CN); Shuhui XIE, Zhejiang (CN)

(73) Assignee: ZHEJIANG SUNON FURNITURE MANUFACTURE CO., LTD., Zhejiang (CN)

(21) Appl. No.: 17/219,899

(22) Filed: Apr. 1, 2021

(30) Foreign Application Priority Data
Aug. 7, 2020 (CN) 202021627819.8

(51) Int. Cl. A47C 7/44; F16C 11/08

(52) U.S. Cl. CPC A47C 7/44; F16C 11/08

(57) ABSTRACT

A chair backrest swing structure includes a chassis connecting seat, a backframe connecting seat and an elastic buffer and reset member. The chassis connecting seat is configured to be cooperatively mounted with a chassis. The backframe connecting seat is configured to be cooperatively mounted with a backframe. The backframe connecting seat is rotatably cooperated with the chassis connecting seat. The elastic buffer and reset member is configured to enable that the backframe connecting seat may implement buffer and reset when swung left and right on the chassis connecting seat.

### CROSS-REFERENCE TO RELATED APPLICATION

This application claims the priority benefit of China application serial no. 202021627819.8, filed on Aug. 7, 2020. The entirety of the above-mentioned patent application is hereby incorporated by reference herein and made a part of this specification.

### BACKGROUND

### Technical Field

The present invention belongs to the field of furniture manufacture, and particularly relates to a chair backrest swing structure.

### Description of Related Art

With the rapid development of scientific technologies and constant increase of social pressures, the health has become an important issue gaining increasingly more concern from the society. The scientific technologies make people indulged in the brain work of bending over a table and sitting for a long time though liberating the manual work, which directly leads to the constant increase of the excessive sitting people in China. People sitting for a long time will continuously adjust the body postures to make the body more comfortable. Upon the movement of the body, the ordinary chair backrest is fixed and cannot make a movement therewith, such that the body of the user cannot be effectively supported. 1. Only some mechanisms in which the backrest swings with the body on existing markets are all provided with one chair for one structure and cannot implement the universality. 2. Some mechanisms are reset undesirably after swung and have a risk of functional failure. 3. Some mechanisms are provided with a variety of assembly structures for the swing function, and gaps caused by the assembly are increased, which results in that the clearances are large during swing. 4. Some swing mechanisms are assembled difficultly and can only be successfully assembled with the assistance of special assembly tools. And 5. Some swing mechanisms must be provided with customized chassis and cannot be used with conventional chassis.

### SUMMARY

In order to make up the shortages of the prior art, the present invention provides technical solutions for a chair backrest swing structure.

A chair backrest swing structure includes a chassis connecting seat, a backframe connecting seat and an elastic buffer and reset member. The chassis connecting seat is configured to be cooperatively mounted with a chassis. The backframe connecting seat is configured to be cooperatively mounted with a backframe, and the backframe connecting seat is rotatably cooperated with the chassis connecting seat. The elastic buffer and reset member is configured to enable that the backframe connecting seat implements buffer and reset when swung left and right on the chassis connecting seat.

According to the chair backrest swing structure, one of the chassis connecting seat and the backframe connecting seat is cooperatively provided with a ball hinge structure, and the other one of the chassis connecting seat and the backframe connecting seat is cooperatively provided with a ball socket structure rotatably cooperated with a ball head of the ball hinge structure.

According to the chair backrest swing structure, the chassis connecting seat and the ball hinge structure are of an integral structure.

According to the chair backrest swing structure, the backframe connecting seat includes a first split body and a second split body. A side of the first split body and a side of the second split body are detachably connected. A spherical groove is provided on a middle portion of each of the first split body and the second split body, and the ball socket structure is formed by the two spherical grooves.

According to the chair backrest swing structure, the first split body and the second split body are of an up-down split structure. The first split body is provided with an upper mounting portion cooperatively mounted with an upper end of the elastic buffer and reset member, the chassis connecting seat is provided with a lower mounting portion cooperatively mounted with a lower end of the elastic buffer and reset member, and the elastic buffer and reset member is mounted between the upper mounting portion and the lower mounting portion.

According to the chair backrest swing structure, two elastic buffer and reset member are respectively disposed on left and right symmetrically.

According to the chair backrest swing structure, the elastic buffer and reset member includes a mold spring.

According to the chair backrest swing structure, the elastic buffer and reset member further includes pressing sheets respectively disposed on upper and lower ends of the mold spring.

According to the chair backrest swing structure, a plurality of chassis mounting holes configured to be cooperatively mounted with the chassis are provided on the chassis connecting seat.

According to the chair backrest swing structure, a plurality of backframe mounting holes configured to be cooperatively mounted with the backframe are provided on the backframe connecting seat.

Compared with the prior art, the present invention has the following beneficial effects. The present invention uses the mold spring as the power that the backrest is swung and reset, so the reset effect is more stable than the torsional spring; the present invention can also implement the swing function in cooperation with the conventional chassis, and thus has the universality. As the present invention designs the ball hinge structure and the chassis connecting seat into a whole, swing clearances when accessories are assembled are reduced. An assembly relationship between the ball hinge structure and the ball socket structure in the present invention uses an up-down sheet closing structure, such that the firm assembly between the ball hinge structure and the ball socket structure may be ensured, and the swing clearances due to the assembly may be reduced.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a first structural schematic diagram of the present invention.

FIG. 2 is a second structural schematic diagram of the present invention.

FIG. 3 is a third structural schematic diagram of the present invention.

FIG. 4 is an exploded structural schematic diagram of the present invention.

### DESCRIPTION OF THE EMBODIMENTS

The present invention will be further described below in combination with the accompanying drawings.

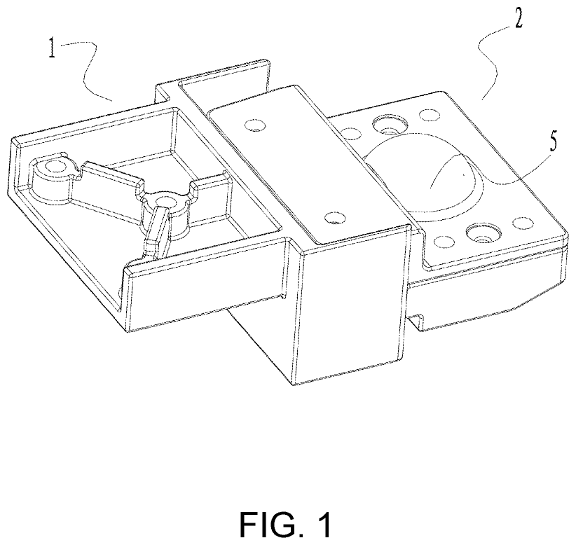

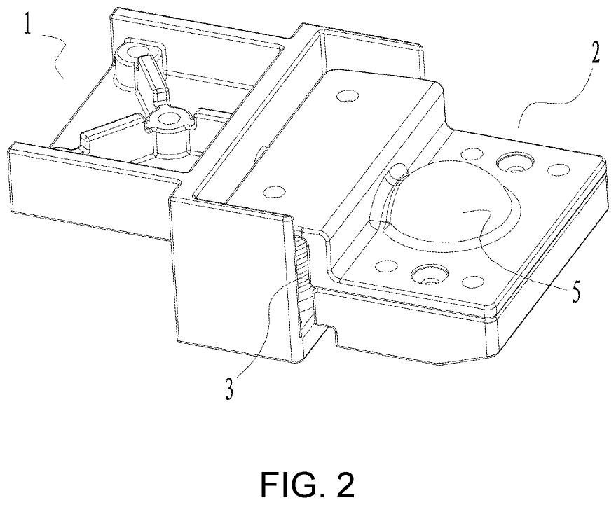

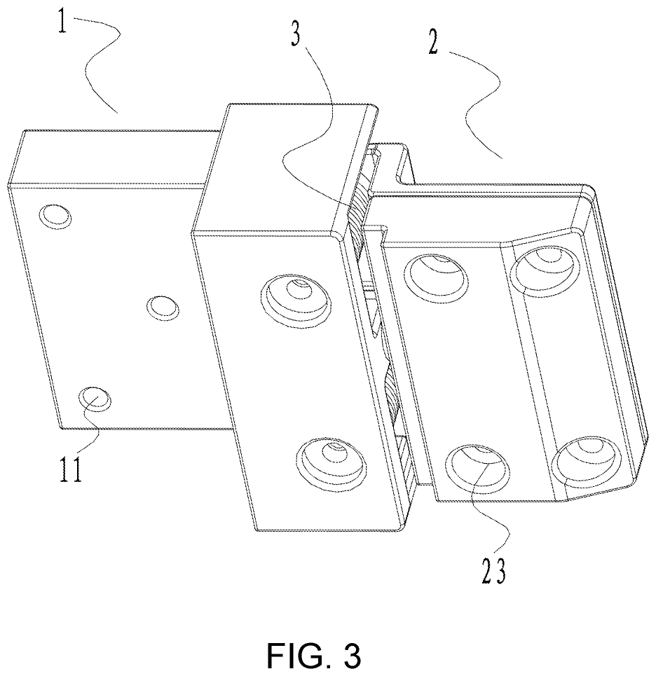

As shown in FIG. 1 to FIG. 3, a chair backrest swing structure includes a chassis connecting seat 1, a backframe connecting seat 2 and an elastic buffer and reset member 3. The chassis connecting seat 1 is cooperatively mounted with a chassis. The backframe connecting seat 2 is cooperatively mounted with a backframe. The backframe connecting seat 2 is rotatably cooperated with the chassis connecting seat 1. The elastic buffer and reset member 3 is configured to enable that the backframe connecting seat 2 may implement buffer and reset when swung left and right on the chassis connecting seat 1.

As an optimization, either the chassis connecting seat 1 or the backframe connecting seat 2 is cooperatively provided with a ball hinge structure 4, and the other one of the chassis connecting seat 1 and the backframe connecting seat 2 is cooperatively provided with a ball socket structure 5 rotatably cooperated with a ball head of the ball hinge structure 4. In other words, the present invention provides two implementation solutions, one of which is that the ball hinge structure 4 is disposed on the chassis connecting seat 1 and the ball socket structure 5 is disposed on the backframe connecting seat 2, and the other of which is that the ball socket structure 5 is disposed on the chassis connecting seat 1, and the ball hinge structure 4 is disposed on the backframe connecting seat 2.

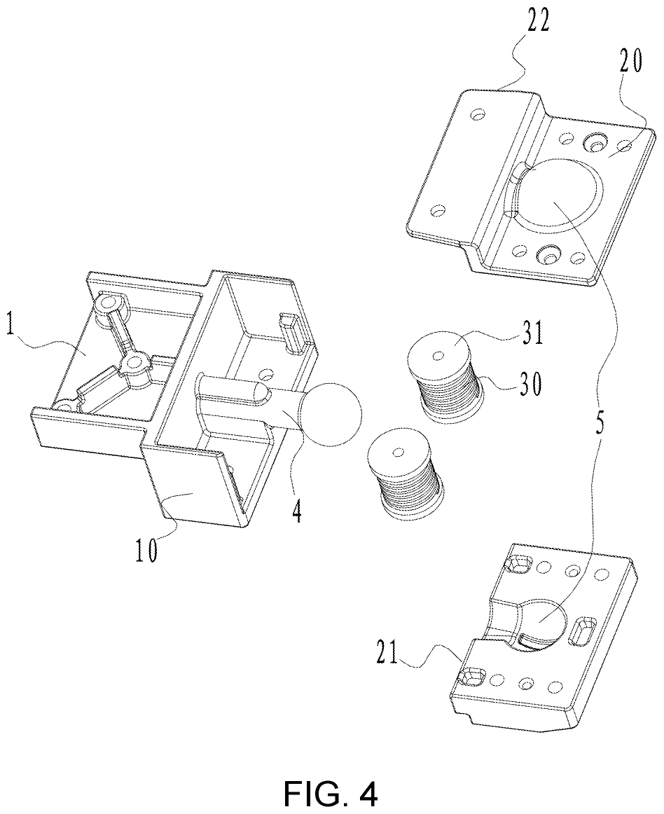

In the above structure, the chassis connecting seat 1 and the ball hinge structure 4 are of an integral structure. As shown in FIG. 4, the backframe connecting seat 2 includes a first split body 20 and a second split body 21 that are of an up-down split structure. A side of the first split body 20 and a side of the second split body 21 are respectively and detachably connected by a bolt. A spherical groove is provided on a middle portion of each of the first split body 20 and the second split body 21, and the ball socket structure 5 is formed by the two spherical grooves. The two split bodies (i.e., the first split body 20 and the second split body 21) are firmly locked up and down by bolts on the two sides, such that the ball hinge structure 4 and the ball socket structure 5 are firmer and the swing clearances due to the assembly can be reduced.

In the above structure, the first split body 20 and the split body 21 are of the up-down split structure, the first split body 20 is provided with an upper mounting portion 22 cooperatively mounted with an upper end of the elastic buffer and reset member 3, the chassis connecting seat 1 is provided with a lower mounting portion 10 cooperatively mounted with a lower end of the elastic buffer and reset member 3, and the elastic buffer and reset member 3 is mounted between the upper mounting portion 22 and the lower mounting portion 10.

As an optimization, two elastic buffer and reset members 3 are disposed on left and right symmetrically.

As an optimization, the elastic buffer and reset member 3 includes a mold spring 30.

In the above structure, the elastic buffer and reset member 3 further includes pressing sheets 31 respectively disposed on upper and lower ends of the mold spring 30. The pressing sheet 31 is fixed with the upper mounting portion 22 and the lower mounting portion 10 by the bolt.

In the above structure, a plurality of chassis mounting holes 11 cooperatively mounted with the chassis are provided on the chassis connecting seat 1.

In the above structure, a plurality of backframe mounting holes 23 cooperatively mounted with the backframe are provided on the backframe connecting seat 2.

In use, when one side of the backframe rotates downward, the backframe drives the backframe connecting seat 2 to rotate downward, and the elastic buffer and reset member 3 at the corresponding position can take the buffer effect and the effect of resetting the backframe connecting seat 2.

The present invention has the following advantages.

1) The present invention uses the mold spring as the power that the backrest is swung and reset, so the reset effect is more stable than the torsional spring.

2) The present invention can also implement the swing function in cooperation with the conventional chassis, and thus has the universality.

3) As the present invention designs the ball hinge structure and the chassis connecting seat into a whole, swing clearances when accessories are assembled are reduced.

4) An assembly relationship between the ball hinge structure and the ball socket structure in the present invention uses an up-down sheet closing structure, such that the firm assembly between the ball hinge structure and the ball socket structure may be ensured, and the swing clearances due to the assembly may be reduced.

Finally, it should be noted that the embodiments above are only used to illustrate rather than to limit the technical solutions of the present invention; although the present invention has been described in detail with reference to the foregoing embodiments, those of ordinary skill in the art should understand that they can still modify the technical solutions described in the foregoing embodiments, or equivalently replace some or all of the technical features therein; and these modifications or replacements do not separate the essence of the corresponding technical solutions from the scope of the technical solutions of each of the embodiments of the present invention.

What is claimed is:

1. A chair backrest swing structure, comprising:
a chassis connecting seat, wherein the chassis connecting seat is configured to be cooperatively mounted with a chassis;
a backframe connecting seat, wherein the backframe connecting seat is configured to be cooperatively mounted with a backframe, and the backframe connecting seat is rotatably cooperated with the chassis connecting seat; and
an elastic buffer and reset member, wherein the elastic buffer and reset member is configured to enable the backframe connecting seat to buffer and reset when swung left and right on the chassis connecting seat.

2. The chair backrest swing structure according to claim 1, wherein one of the chassis connecting seat and the backframe connecting seat is provided with a ball hinge structure, and the other one of the chassis connecting seat and the backframe connecting seat is provided with a ball socket structure rotatably cooperated with a ball head of the ball hinge structure.

3. The chair backrest swing structure according to claim 2, wherein the chassis connecting seat and the ball hinge structure are of an integral structure.

4. The chair backrest swing structure according to claim 2, wherein the backframe connecting seat comprises a first split body and a second split body, a side of the first split body and a side of the second split body are detachably connected, a spherical groove is provided on a middle portion of each of the first split body and the second split body, and the ball socket structure is formed by the two spherical grooves.

5. The chair backrest swing structure according to claim 4, wherein the first split body and the second split body are of an up-down split structure, the first split body is provided with an upper mounting portion cooperatively mounted with an upper end of the elastic buffer and reset member, the chassis connecting seat is provided with a lower mounting portion cooperatively mounted with a lower end of the elastic buffer and reset member, and the elastic buffer and reset member is mounted between the upper mounting portion and the lower mounting portion.

6. The chair backrest swing structure according to claim 1, wherein two elastic buffer and reset members are respectively disposed on left and right symmetrically.

7. The chair backrest swing structure according to claim 1, wherein the elastic buffer and reset member comprises a mold spring.

8. The chair backrest swing structure according to claim 7, wherein the elastic buffer and reset member further comprises pressing sheets respectively disposed on upper and lower ends of the mold spring.

9. The chair backrest swing structure according to claim 1, wherein a plurality of chassis mounting holes configured to be mounted with the chassis are provided on the chassis connecting seat.

10. The chair backrest swing structure according to claim 1, wherein a plurality of backframe mounting holes configured to be mounted with the backframe are provided on the backframe connecting seat.
